(19) United States
(12) Patent Application Publication
(10) Pub. No.: US 2026/0194347 A1
(43) Pub. Date: Jul. 9, 2026

(54) METHOD FOR MEASURING STATE OF ROTARY MEMBER

(71) Applicant: SANKYO SEISAKUSHO CO., Tokyo (JP)

(72) Inventor: Naoyuki TAKAHASHI, Kikugawa (JP)

(73) Assignee: SANKYO SEISAKUSHO CO., Tokyo (JP)

(21) Appl. No.: 19/132,100

(22) PCT Filed: Nov. 1, 2023
(86) PCT No.: PCT/JP2023/039417

§ 371 Date: May 22, 2025

(30) Foreign Application Priority Data
Nov. 30, 2022 (JP) 2022-191822

(51) Int. Cl. G01C 9/02

(52) U.S. Cl. CPC G01C 9/02

(57) ABSTRACT

Provided is a method for measuring the state of a rotary member that is capable of rotating about a rotary member axis line. The method comprises: a step for disposing a measuring device on a measurement surface of a rotary member; a step for disposing the rotary member at a given measurement angle of which the center is located at a rotary member axis line; a step for disposing a support member for the measuring device so as to enable an angle detector of the measuring device to detect a rotational angle which corresponds to said measurement angle and of which the center is located at a support member axis line; a step for measuring, by means of an inclination detector of the measuring device, the inclination angle of the inclination detector with respect to a measurement reference surface at the rotational angle of the support member; and a step for measuring the state of the rotary member at least on the basis of the inclination angle.

### TECHNICAL FIELD

The present invention relates to a method capable of directly, highly precisely, and simply measuring a state of a rotary member.

### BACKGROUND ART

A workpiece is processed and/or inspected while a rotary member is being rotated, with the workpiece disposed at any position on a surface of the rotary member rotatable about the rotary member axis line. When highly precise positioning of the workpiece for processing and/or inspection is required, the parallelism of the rotary member axis line with respect to a reference surface and the parallelism of the surface of the rotary member with respect to the rotary member axis line need to be highly precisely adjusted. When the workpiece disposed on the surface of the rotary member is processed without the parallelism being adjusted, a processing error in the workpiece occurs. Conventionally, the parallelism has been measured such that with a precision straightedge fixed on the surface of the rotary member as a measurement surface, scanning is performed on the surface of the rotary member with a test indicator or the like, using, for example, a precision surface plate or a three-dimensional measuring device so as to calculate the scanning results. Specifically, the rotary member is positioned at three orientations with inclination angles of 0°, −90°, and +90° with respect to a direction perpendicular to the reference surface, and at each orientation, a difference in displacement between two points on the straightedge fixed on the surface of the rotary member along directions parallel and perpendicular to the rotary member is measured, so that the parallelism is measured by calculating the six measured differences in displacement.

Patent Literature 1 discloses a mobile environment recognition method in which by projecting, onto a measurement target, a conical scanning detection light for scanning in a direction along a conical surface from a sensor origin centered on a collimation direction and receiving the conical scanning detection light reflected from an intersection circle between the conical scanning detection light and the surface of the measurement target, the distance from the sensor origin to the measurement target is measured so as to calculate the feature amount of the intersection circle based on the measured distance, so that the shape of the surface of the measurement target is obtained from the feature amount of the intersection circle.

### CITATION LIST

### Patent Literature

PATENT LITERATURE 1: JP-A-2011-059071
PATENT LITERATURE 2: JP-A-2006-98392
PATENT LITERATURE 3: JP-A-2011-99802
PATENT LITERATURE 4: JP-A-2011-99804

### SUMMARY OF INVENTION

### Technical Problem

A precision surface plate, a three-dimensional measuring device, etc. generally require a large-scale facility, not allowing a measurement environment to be constructed in a small space, and further, cannot be installed at an assembly site of a rotary device such as an inclination circular table where a rotary member is mounted, so that there is a problem of failing to simply measure the parallelism. In addition, there is a problem of poor productivity in that for the adjustment of parallelism, it is necessary to repeat transporting the rotary device such as the inclination circular table to the measurement environment to measure the parallelism, then transporting it to an assembly site to be disassembled and adjusted, and transporting it to the measurement environment again to measure the parallelism.

The mobile environment recognition method of Patent Literature 1 has a problem in that the measurement result of the distance from a sensor origin to a measurement target changes depending on the orientation of the measurement target, and the feature amount of an intersection circle obtained from the measurement result also changes, so that the shape of the surface of the measurement target to be obtained also changes.

Accordingly, an object of the present invention is to provide a method capable of solving the aforementioned problems and directly, highly precisely, and simply measuring the state of a rotary member.

### Solution to Problem

According to one aspect of the present invention, a method for measuring a state of a rotary member rotatable about a rotary member axis line includes the steps of: disposing a measuring device on a measurement surface of the rotary member, the measuring device including: a rotating mechanism; a support member that can be rotated about a support member axis line by the rotating mechanism; an angle detector that detects a rotation angle of the support member; and an inclination detector that is disposed on the support member and detects an inclination angle of the inclination detector with respect to a measurement reference surface; disposing the rotary member at a first measurement angle centered on the rotary member axis line; disposing the support member such that a first rotation angle centered on the support member axis line corresponding to the first measurement angle is detected by the angle detector; measuring a first inclination angle of the inclination detector with respect to the measurement reference surface at the first rotation angle of the support member by the inclination detector; and measuring the state of the rotary member based on at least the first inclination angle.

According to one specific example of the present invention, the method further includes the steps of: rotating the rotary member from the first measurement angle to a second measurement angle about the rotary member axis line; rotating the support member such that a second rotation angle centered on the support member axis line corresponding to the second measurement angle is detected by the angle detector; measuring a second inclination angle of the inclination detector with respect to the measurement reference surface at the second rotation angle of the support member by the inclination detector; and measuring the state of the rotary member further based on the second inclination angle.

According to one specific example of the present invention, the method further includes the steps of: rotating the rotary member from the second measurement angle to a third measurement angle about the rotary member axis line; rotating the support member such that a third rotation angle centered on the support member axis line corresponding to the third measurement angle is detected by the angle detector; measuring a third inclination angle of the inclination detector with respect to the measurement reference surface at the third rotation angle of the support member by the inclination detector; and measuring the state of the rotary member further based on the third inclination angle.

According to one specific example of the present invention, the method further includes the steps of: measuring a fourth inclination angle of the inclination detector with respect to the measurement reference surface by the inclination detector, by arranging the measurement surface so as to be parallel to the measurement reference surface; and measuring the state of the rotary member further based on the fourth inclination angle.

According to one specific example of the present invention, the method further includes the step of adjusting an angular position of the inclination detector so as to be aligned with the support member axis line.

According to one specific example of the present invention, the method further includes the steps of: measuring a fifth inclination angle of the inclination detector with respect to the measurement surface, by disposing the support member at a first angle centered on the support member axis line; measuring a sixth inclination angle of the inclination detector with respect to the measurement surface, by rotating the support member by 180° from the first angle to a second angle about the support member axis line; and measuring an inclination angle of the support member axis line with respect to the measurement surface based on the fifth inclination angle and the sixth inclination angle.

According to one specific example of the present invention, in the method, the inclination detector is a spirit level.

According to one specific example of the present invention, in the method, the state of the rotary member includes parallelism of the rotary member axis line with respect to the measurement reference surface.

According to one specific example of the present invention, in the method, the state of the rotary member includes parallelism of the measurement surface with respect to the rotary member axis line.

According to one specific example of the present invention, in the method, the first measurement angle, the second measurement angle, and the third measurement angle are an angle of 0°, 90°, or −90° centered on the rotary member axis line with respect to a direction perpendicular to the measurement reference surface.

### Advantageous Effects of Invention

According to the present invention, the method makes it possible to directly, highly precisely, and simply measure the state of the rotary member.

Other objects, features, and advantages of the present invention will become apparent from the following description of the embodiments of the present invention taken in conjunction with the accompanying drawings.

### BRIEF DESCRIPTION OF DRAWINGS

FIG. 1A is a perspective view of a measuring device used in a method for measuring a state of a rotary member according to an embodiment of the present invention.

FIG. 1B is a perspective view of the measuring device according to the embodiment of FIG. 1A, as seen from a direction different from that of FIG. 1A.

FIG. 2 is a perspective view showing a state in which the measuring device according to the embodiment of FIG. 1A is disposed on a measurement surface of the rotary member of an inclination circular table.

FIG. 3A is a side view showing a state in which the measuring device according to the embodiment of FIG. 1A is disposed on the measurement surface of the rotary member.

FIG. 3B is a top view of the state of FIG. 3A.

FIG. 3C is a side view showing a state in which the rotary member and a support member are rotated from the state of FIG. 3A.

FIG. 3D is a top view of the state of FIG. 3C.

FIG. 3E is a side view showing a state in which the rotary member and the support member are rotated from the state of FIG. 3A in a direction opposite to the state of FIG. 3C.

FIG. 3F is a top view of the state of FIG. 3E.

FIG. 4A is a side view showing a state in which the measuring device according to the embodiment of FIG. 1A is disposed on the measurement surface of the rotary member.

FIG. 4B is a side view showing a state in which the support member is rotated from the state of FIG. 4A.

FIG. 5A is a top view of the measuring device according to the embodiment of FIG. 1A.

FIG. 5B is a side view showing a state in which the support member is rotated from a state of FIG. 5A.

FIG. 5C is a side view showing a state in which the support member is rotated from the state of FIG. 5A in a direction opposite to the state of FIG. 5B.

FIG. 6A is a side view showing a state in which an inclination detector of the measuring device according to the embodiment of FIG. 1A is rotated around a y-axis.

FIG. 6B is a top view showing a state in which the inclination detector is rotated around a z-axis from the state of FIG. 6A.

FIG. 6C is a side view showing a state in which the support member is rotated around an x-axis from the state of FIG. 6B.

FIG. 6D is a side view showing a state in which the measuring device is rotated around the y-axis from the state of FIG. 6C.

FIG. 6E is a top view showing a state in which the measuring device is rotated around the z-axis from the state of FIG. 6D.

FIG. 6F is a side view showing a state in which the rotary member is rotated around the x-axis from the state of FIG. 6E.

FIG. 6G is a side view showing a state in which the inclination circular table is rotated around the y-axis from the state of FIG. 6F.

### DESCRIPTION OF EMBODIMENTS

Embodiments according to the present invention will be described with reference to the drawings. However, the present invention is not limited to those embodiments.

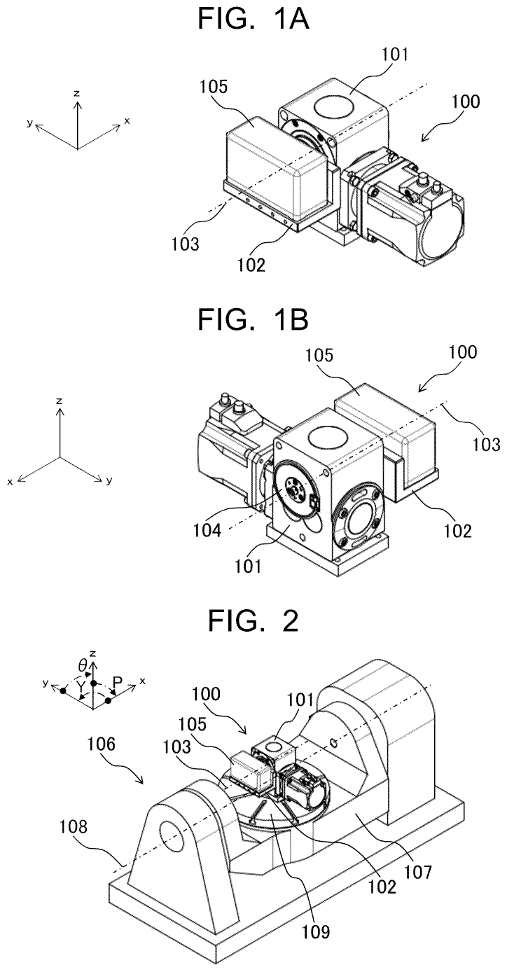

With reference to FIG. 1A to FIG. 6G, a method for measuring a state of a rotary member 107 as one embodiment of the present invention will be described. The rotary member 107 is rotatable about a rotary member axis line 108. The rotary member 107 may be mounted on an inclination circular table 106 for measuring its state. The inclination circular table 106 is provided on a measurement reference surface 110. The inclination circular table 106 does not necessarily need to be provided on the measurement reference surface 110, and may be provided on a wall surface or the like. Note that the rotary member 107 may be mounted on another rotary device as long as it is rotatable about the rotary member axis line 108.

A measuring device 100 includes a rotating mechanism 101, a support member 102 that can be rotated about a support member axis line 103 by the rotating mechanism 101, an angle detector 104 for detecting a rotation angle of the support member 102, and an inclination detector 105 disposed on the support member 102. The inclination detector 105 detects an inclination angle of the inclination detector 105 with respect to the measurement reference surface 110. The rotating mechanism 101 may include a motor, a reducer, a cam mechanism, or the like to rotate the support member 102, but is not limited thereto, and may be one that can simply rotate the support member 102 or may be one that rotates the support member 102 manually. The angle detector 104 may be a rotary encoder, a resolver, an inductosyn, or the like for detecting the rotation angle of the support member 102, but is not limited thereto, and is preferably one that is capable of highly precisely detecting the rotation angle of the order of 1/3600° (1 arcsec) or lower, and may be, for example, an angle detector with a self-calibration function as disclosed in Patent Literatures 2 to 4. The inclination detector 105 may be a spirit level, a level, an inclination sensor, or the like for detecting the inclination angle of the support member 102 with respect to the measurement reference surface 110, but is not limited thereto, and is preferably one that is capable of highly precisely detecting the inclination angle of the order of 1/3600° or lower. Note that the measurement reference surface 110 may be the ground, an attachment surface of a machine tool on which the inclination circular table 106 is provided, or a bed, a table surface, or the like of the machine tool. The measuring device 100 may include a control unit that causes the rotating mechanism 101 to rotate the support member 102, causes the angle detector 104 to detect the rotation angle of the support member 102, and causes the inclination detector 105 to detect the inclination angle of the inclination detector 105, for automatically measuring the state of the rotary member 107.

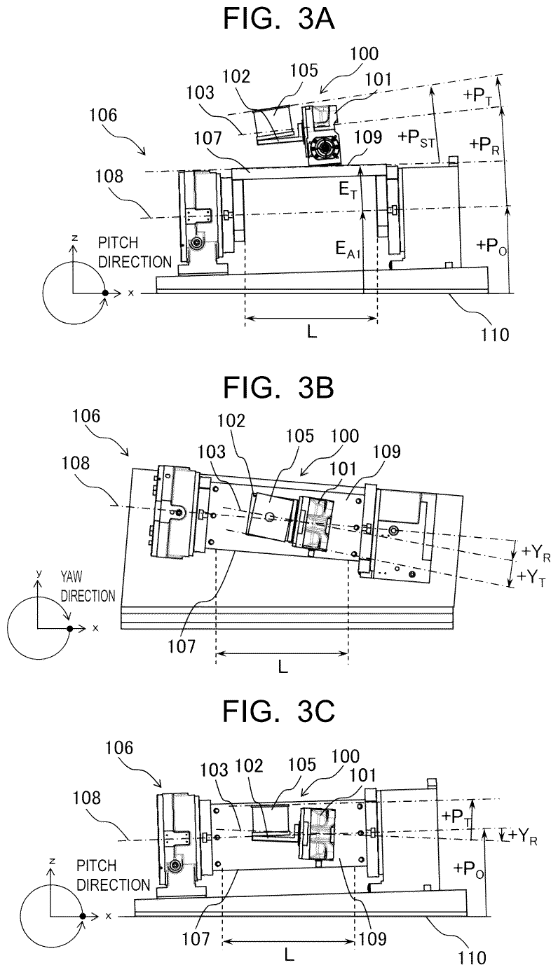

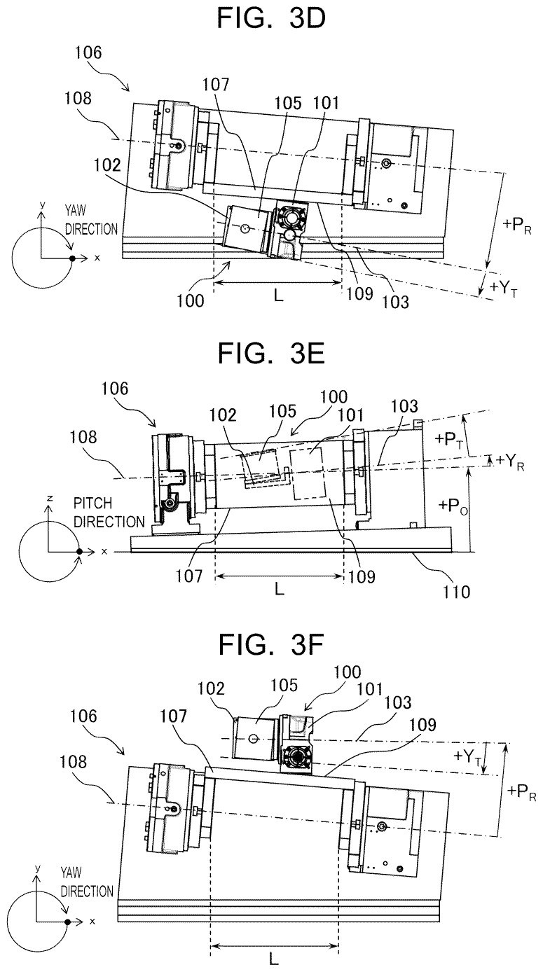

The method includes a step of disposing the measuring device 100 on a measurement surface 109 of the rotary member 107. When the measuring device 100 is disposed on the measurement surface 109, at the position of the inclination detector 105, as shown in FIG. 3A and FIG. 3B, an inclination angle error P_{O} in a pitch direction of the rotary member axis line 108 with respect to the measurement reference surface 110, an inclination angle error P_{R} in a pitch direction of the support member axis line 103 with respect to the rotary member axis line 108, an inclination angle error P_{T} in a pitch direction of the inclination detector 105 with respect to the support member axis line 103, an inclination angle error P_{ST} in the pitch direction of the inclination detector 105 with respect to the measurement surface 109 of the rotary member 107, an inclination angle error Y_{R} in a yaw direction of the support member axis line 103 with respect to the rotary member axis line 108, and an inclination angle error Y_{T} in a yaw direction of the inclination detector 105 with respect to the support member axis line 103 occur. Note that for a matter of convenience, for the inclination angle errors in the pitch direction, the angles in the counterclockwise direction are assumed to be positive angles, and for the inclination angle errors in the yaw direction, the angles in the clockwise direction are assumed to be positive angles.

The method includes a step of disposing the rotary member 107 at a first measurement angle centered on the rotary member axis line 108. The rotary member 107 is disposed at a given measurement angle θ₁ in the roll direction centered on the rotary member axis line 108 with respect to a direction perpendicular to the measurement reference surface 110. For example, as shown in FIG. 3A and FIG. 3B, the rotary member 107 may be disposed at a measurement angle of 0° in the roll direction centered on the rotary member axis line 108 with respect to the direction perpendicular to the measurement reference surface 110. Further, the method includes a step of disposing the support member 102 such that a first rotation angle centered on the support member axis line 103 corresponding to the first measurement angle is detected by the angle detector 104. With the rotary member 107 disposed at the first measurement angle, while the rotation angle of the support member 102 is being detected by the angle detector 104, the support member 102 is disposed by the rotating mechanism 101 at a rotation angle −θ₁ opposite to the measurement angle θ₁ of the rotary member 107 in the roll direction centered on the support member axis line 103 with respect to the direction perpendicular to the measurement reference surface 110. For example, as shown in FIG. 3A and FIG. 3B, the support member 102 may be disposed by the rotating mechanism 101 at a rotation angle of 0° in the roll direction centered on the support member axis line 103 with respect to the direction perpendicular to the measurement reference surface 110. Furthermore, the method includes a step of measuring, by the inclination detector 105, a first inclination angle of the inclination detector 105 with respect to the measurement reference surface 110 at the first rotation angle of the support member 102. With the support member 102 disposed at the rotation angle −θ₁, the inclination detector 105 measures a first inclination angle ΔP₁ of the inclination detector 105 with respect to the measurement reference surface 110. For example, as shown in FIG. 3A and FIG. 3B, the inclination detector 105 may measure an inclination angle Δθ_{b} of the inclination detector 105 with respect to the measurement reference surface 110 at a rotation angle of 0° of the support member 102. As shown in FIG. 3A, when for the inclination angle errors Pₒ, P_{R}, and P_{T}, the angles in the counterclockwise direction are assumed to be positive angles, and the angle in the counterclockwise direction is assumed to be a positive angle for the inclination angle Δθ_{b} measured by the inclination detector 105 as well, the inclination detector 105 can measure the inclination angle Δθ_{b}=P_{O}+P_{R}+P_{T}. Further, the method includes a step of measuring the state of the rotary member 107 based on at least the first inclination angle. For example, the state of the rotary member 107 can be measured by using the inclination angle Δθ_{b}=P_{O}+P_{R}+P_{T} measured by the inclination detector 105. For example, by measuring or adjusting the inclination angle error P_{R} and the inclination angle error P_{T} in advance, the inclination angle error P_{O} as the state of the rotary member 107 can be measured using one inclination angle Δθ_{b}=P_{O}+P_{R}+P_{T} measured by the inclination detector 105.

The method includes a step of rotating the rotary member 107 from the first measurement angle to a second measurement angle about the rotary member axis line 108. The rotary member 107 is rotated in the roll direction about the rotary member axis line 108 from the measurement angle θ₁ to a given measurement angle θ₂. For example, as shown in FIG. 3C and FIG. 3D, the rotary member 107 may be rotated in the roll direction about the rotary member axis line 108 from a measurement angle of 0° to a measurement angle of 90°. Further, the method includes a step of rotating the support member 102 such that a second rotation angle centered on the support member axis line 103 corresponding to the second measurement angle is detected by the angle detector 104. With the rotary member 107 disposed at the second measurement angle, while the rotation angle of the support member 102 is being detected by the angle detector 104, the support member 102 is rotated by the rotating mechanism 101 in the roll direction about the support member axis line 103 from the rotation angle −θ₁ to a rotation angle −θ₂ in a direction opposite to the rotation of the rotary member 107 from the measurement angle θ₁ to the measurement angle θ₂. For example, as shown in FIG. 3C and FIG. 3D, the support member 102 is rotated by the rotating mechanism 101 in the roll direction about the support member axis line 103 from a rotation angle of 0° to a rotation angle of −90° in a direction opposite to the rotation of the rotary member 107 from a measurement angle of 0° to a measurement angle of 90°. Further, the method includes a step of measuring a second inclination angle of the inclination detector 105 with respect to the measurement reference surface 110 at the second rotation angle of the support member 102 by the inclination detector 105. With the support member 102 disposed at the rotation angle −θ₂, the inclination detector 105 measures a second inclination angle ΔP₂ of the inclination detector 105 with respect to the measurement reference surface 110. For example, as shown in FIG. 3C and FIG. 3D, the inclination detector 105 may measure an inclination angle Δθ_{d} of the inclination detector 105 with respect to the measurement reference surface 110 at a rotation angle of −90° of the support member 102. As shown in FIG. 3C, when for the inclination angle errors P_{O}, Y_{R}, and P_{T}, the angles in the counterclockwise direction are assumed to be positive angles, and the angle in the counterclockwise direction is assumed to be a positive angle for the inclination angle Δθ_{d} measured by the inclination detector 105 as well, the inclination detector 105 can measure the inclination angle Δθ_{d}=P_{O}−Y_{R}+P_{T}. Further, the method includes a step of measuring the state of the rotary member 107 further based on the second inclination angle. For example, the state of the rotary member 107 can be measured by using the inclination angle Δθ_{d}=P_{O}−Y_{R}+P_{T} measured by the inclination detector 105.

The method includes a step of rotating the rotary member 107 from the second measurement angle to a third measurement angle about the rotary member axis line 108. The rotary member 107 is rotated in the roll direction about the rotary member axis line 108 from the measurement angle θ₂ to a given measurement angle θ₃. For example, as shown in FIG. 3E and FIG. 3F, the rotary member 107 may be rotated in the roll direction about the rotary member axis line 108 from a measurement angle of 90° to a measurement angle of −90°. Further, the method includes a step of rotating the support member 102 such that a third rotation angle centered on the support member axis line 103 corresponding to the third measurement angle is detected by the angle detector 104. With the rotary member 107 disposed at the third measurement angle, while the rotation angle of the support member 102 is being detected by the angle detector 104, the support member 102 is rotated by the rotating mechanism 101 in the roll direction about the support member axis line 103 from the rotation angle −θ₂ to a rotation angle −θ₃ in a direction opposite to the rotation of the rotary member 107 from the measurement angle θ₂ to the measurement angle θ₃. For example, as shown in FIG. 3E and FIG. 3F, the support member 102 is rotated by the rotating mechanism 101 in the roll direction about the support member axis line 103 from a rotation angle of −90° to a rotation angle of 90° in a direction opposite to the rotation of the rotary member 107 from a measurement angle of 90° to a measurement angle of −90°. Further, the method includes a step of measuring a third inclination angle of the inclination detector 105 with respect to the measurement reference surface 110 at the third rotation angle of the support member 102 by the inclination detector 105. With the support member 102 disposed at the rotation angle −θ₃, the inclination detector 105 measures a third inclination angle ΔP₃ of the inclination detector 105 with respect to the measurement reference surface 110. For example, as shown in FIG. 3E and FIG. 3F, the inclination detector 105 may measure an inclination angle Δθ_{f} of the inclination detector 105 with respect to the measurement reference surface 110 at a rotation angle of 90° of the support member 102. As shown in FIG. 3E, when for the inclination angle errors P_{O}, Y_{R}, and P_{T}, the angles in the counterclockwise direction are assumed to be positive angles, and the angle in the clockwise direction is assumed to be a positive angle for the inclination angle 40f measured by the inclination detector 105, the inclination detector 105 can measure the inclination angle Δθ_{f}=−P_{O}−Y_{R}−P_{T}. Further, the method includes a step of measuring the state of the rotary member 107 further based on the third inclination angle. For example, the state of the rotary member 107 can be measured by using the inclination angle Δθ_{f}=−P_{O}−Y_{R}−P_{T} measured by the inclination detector 105. For example, by measuring or adjusting the inclination angle error P_{T} in advance, the inclination angle error P_{O} as the state of the rotary member 107 can be measured using the two inclination angles Δθ_{d}=P_{O}−Y_{R}+P_{T} and Δθ_{f}=−P_{O}−Y_{R}−P_{T} measured by the inclination detector 105.

With the use of the measured inclination angles Δθ_{b}, Δθ_{d}, and Δθ_{f}, the inclination angle error P_{R} is obtained as the state of the rotary member 107 as follows:

$${P}_{R} = \frac{2 {Δθ}_{b} - {Δθ}_{d} + {Δθ}_{f}}{2} \qquad [ MATH . 1 ]$$

Further, the inclination angle error Y_{R} is obtained as the state of the rotary member 107 as follows.

$${Y}_{R} = \frac{- {Δθ}_{d} - {Δθ}_{f}}{2} \qquad [ MATH . 2 ]$$

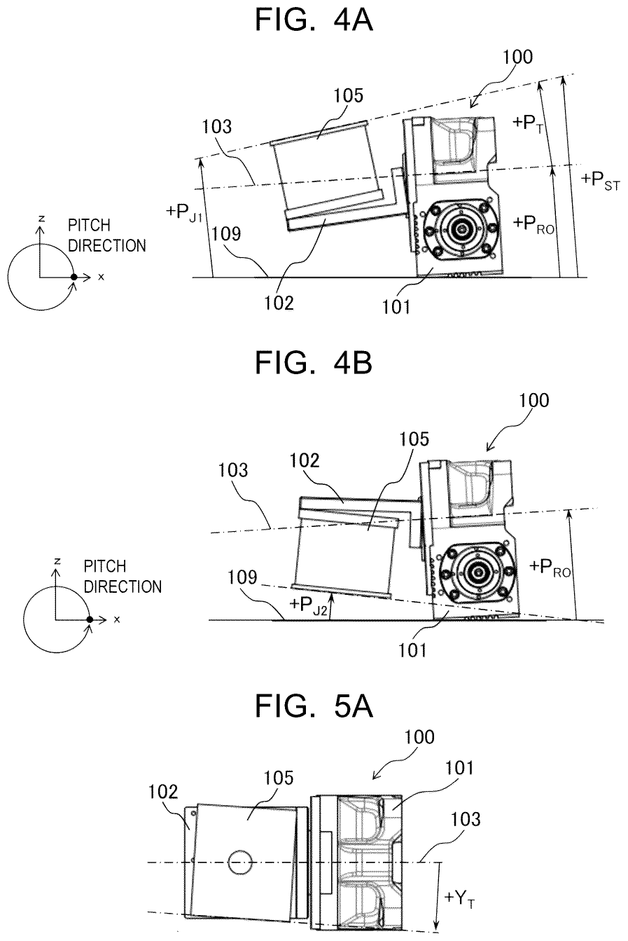

The method includes a step of measuring a fourth inclination angle of the inclination detector 105 with respect to the measurement reference surface 110 by the inclination detector 105, by arranging the measurement surface 109 so as to be parallel to the measurement reference surface 110. With the measurement surface 109 arranged so as to be parallel to the measurement reference surface 110, the inclination detector 105 measures a fourth inclination angle ΔP₄ of the inclination detector 105 with respect to the measurement reference surface 110. For example, as shown in FIG. 4A, the inclination detector 105 may measure the inclination angle error P_{ST} by disposing the support member 102 at a rotation angle of 0° in the roll direction centered on the support member axis line 103 with respect to the direction perpendicular to the measurement reference surface 110 by the rotating mechanism 101. Further, using a test indicator or the like, the inclination angle of the rotary member 107 is measured from a displacement amount of the rotary member 107 in the z-axis direction relative to the distance between two points in the x-axis direction, and the inclination angle of the inclination detector 105 is measured from a displacement amount of the inclination detector 105 in the z-axis direction relative to the distance between two points in the x-axis direction, so that the fourth inclination angle ΔP₄ of the inclination detector 105 with respect to the measurement reference surface 110 may be measured from a difference between the inclination angle of the inclination detector 105 and the inclination angle of the rotary member 107.

The method includes a step of measuring a fifth inclination angle of the inclination detector 105 with respect to the measurement surface 109, by disposing the support member 102 at a first angle centered on the support member axis line 103. While the rotation angle of the support member 102 is being detected by the angle detector 104, the support member 102 is disposed by the rotating mechanism 101 at a given rotation angle θ₄ in the roll direction centered on the support member axis line 103 with respect to the direction perpendicular to the measurement reference surface 110. For example, as shown in FIG. 4A, the support member 102 may be disposed by the rotating mechanism 101 at a rotation angle of 0° in the roll direction centered on the support member axis line 103 with respect to the direction perpendicular to the measurement reference surface 110. With the support member 102 disposed at the rotation angle θ₄, the inclination detector 105 measures a fifth inclination angle ΔP₅ of the inclination detector 105 with respect to the measurement reference surface 110. For example, as shown in FIG. 4A, the inclination detector 105 may measure an inclination angle P_{J1} of the inclination detector 105 with respect to the measurement reference surface 110 at a rotation angle of 0° of the support member 102. Further, the method includes a step of measuring a sixth inclination angle of the inclination detector 105 with respect to the measurement surface 109, by rotating the support member by 180° from the first angle to a second angle about the support member axis line. While the rotation angle of the support member 102 is being detected by the angle detector 104, the support member 102 is rotated by 180° in the roll direction about the support member axis line 103 from the rotation angle θ₄ to a rotation angle θ₅ by the rotating mechanism 101. For example, as shown in FIG. 4B, the support member 102 may be rotated by 180° in the roll direction about the support member axis line 103 from a rotation angle of 0° to a rotation angle of 180° by the rotating mechanism 101. With the support member 102 disposed at the rotation angle θ₅, the inclination detector 105 measures a sixth inclination angle ΔP₆ of the inclination detector 105 with respect to the measurement reference surface 110. For example, as shown in FIG. 4B, the inclination detector 105 may measure an inclination angle P_{J2} of the inclination detector 105 with respect to the measurement reference surface 110 at a rotation angle of 180° of the support member 102. Further, the method includes a step of measuring the inclination angle of the support member axis line 103 with respect to the measurement surface 109 based on the fifth inclination angle and the sixth inclination angle. With the use of the inclination angles P_{J1} and P_{J2} measured by the inclination detector 105, an inclination angle P_{Ro} in the pitch direction of the inclination detector 105 with respect to the measurement surface 109 of the rotary member 107 is obtained as follows:

$${P}_{R 0} = \frac{{P}_{J 1} + {P}_{J 2}}{2} \qquad [ MATH . 3 ]$$

Further, with the use of the inclination angle error P_{ST} and the inclination angles P_{J1} and P_{J2} measured by the inclination detector 105, the inclination angle error P_{T} is obtained as follows:

$${P}_{T} = {P}_{ST} - {P}_{R 0} = {P}_{ST} - \frac{{P}_{J 1} + {P}_{J 2}}{2} \qquad [ MATH . 4 ]$$

Further, the method may include a step of measuring the state of the rotary member 107 based on the fourth inclination angle, as well as the fifth inclination angle and the sixth inclination angle, or may include a step of measuring the state of the rotary member 107 based on the fourth inclination angle by adjusting the inclination angle error P_{T} to 0 using the fourth inclination angle and/or the fifth inclination angle and the sixth inclination angle.

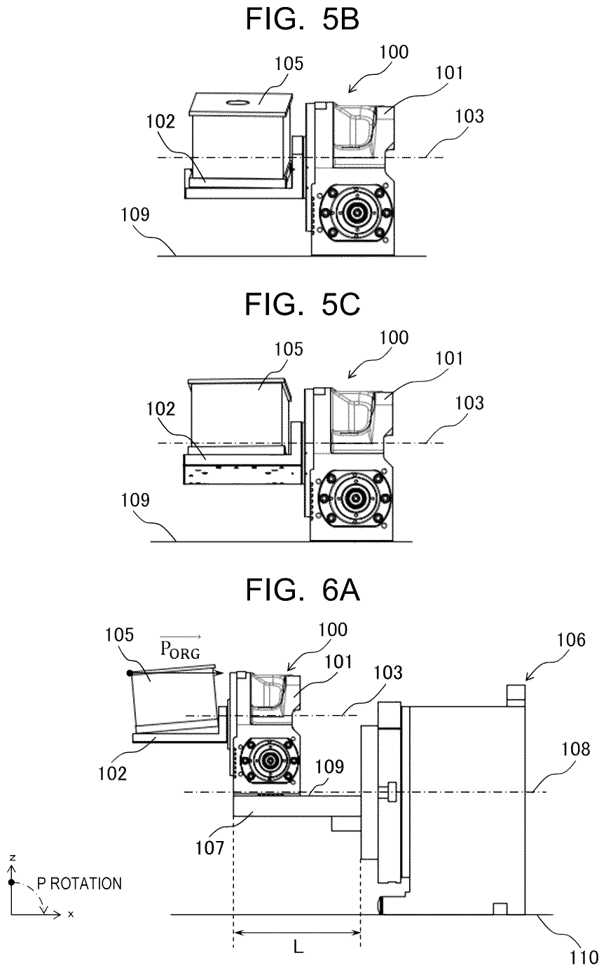

The method includes a step of adjusting an angular position of the inclination detector 105 so as to be aligned with the support member axis line 103. When the inclination detector 105 is disposed on the support member 102, the inclination angle error Y_{T} occurs depending on the position of the inclination detector 105, as shown in FIG. 5A. After the support member 102 is disposed at a given rotation angle θ₆ in the roll direction centered on the support member axis line 103 with respect to the direction perpendicular to the measurement reference surface 110, while the rotation angle of the support member 102 is being detected by the angle detector 104, the support member 102 is rotated by the rotating mechanism 101 in the roll direction about the support member axis line 103 from the rotation angle θ₆ to a rotation angle θ₆+α, as shown in FIG. 5B. Then, with the support member 102 disposed at the rotation angle θ₆+α, the inclination detector 105 measures a seventh inclination angle ΔP₇ of the inclination detector 105 with respect to the measurement reference surface 110. Next, as shown in FIG. 5C, while the rotation angle of the support member 102 is being detected by the angle detector 104, the support member 102 is rotated in the roll direction about the support member axis line 103 by the rotating mechanism 101 from the rotation angle θ₆+α to a rotation angle θ₆−α. Then, with the support member 102 disposed at the rotation angle θ₆−α, the inclination detector 105 measures an eighth inclination angle ΔP₈ of the inclination detector 105 with respect to the measurement reference surface 110. By adjusting the angular position of the inclination detector 105 with respect to the support member axis line 103 so that the inclination detector 105 is aligned with the support member axis line 103 until the measured seventh inclination angle ΔP₇ and eighth inclination angle ΔP₈ match with each other, the inclination angle error Y_{T} can be adjusted to 0.

With the use of the measured inclination angles 40b, 40d, and Δθ_{f}, the inclination angle error P_{O} is obtained as the state of the rotary member 107 as follows.

$${P}_{0} = {Δθ}_{b} - {P}_{R} - {P}_{T} = \frac{{Δθ}_{d} - {Δθ}_{f}}{2} - {P}_{T} \qquad [ MATH . 5 ]$$

When parallelism is defined as a displacement amount per given distance L, and the length of the rotary member 107 in the direction of the rotary member axis line 108 is assumed to be L, a parallelism E_{A1} of the rotary member axis line 108 per length L of the rotary member 107 with respect to the measurement reference surface 110 is obtained as the state of the rotary member 107 as follows.

$${E}_{A 1} = L tan ( {P}_{0} ) \qquad [ MATH . 6 ]$$

Further, a parallelism E_{T} of the measurement surface 109 of the rotary member 107 per length L of the rotary member 107 with respect to the rotary member axis line 108 is obtained as the state of the rotary member 107 as follows.

$${E}_{T} = L tan ( {P}_{R} + {P}_{T} - {P}_{ST} ) \qquad [ MATH . 7 ]$$

For example, in a case where an inclination angle error is present only in the pitch direction (i.e., the inclination angle errors Y_{R}, Y_{T}=) 0°, and the inclination angle error P_{T}=4° and the inclination angle error P_{ST}=0° are measured in advance, when the three inclination angle errors Δθ_{b}=P_{O}+P_{R}+P_{T}=8.9°, Δθ_{d}=P_{O}−Y_{R}+P_{T}=5.7°, and Δθ_{f}=−P_{O}−Y_{R}−P_{T}=−5.7° are measured, the inclination angle error P_{O}=1.7° and the inclination angle error P_{R}=3.2° are obtained, and when the length L of the rotary member 107 is assumed to be 300 mm, the parallelism E_{A1}=L tan (P_{O})=300×tan (1.7°)=8.9 mm is obtained and the parallelism E_{T}=L tan (P_{R}+P_{T}−P_{ST})=300× tan (3.2°+4°−0°)=37.9 mm is obtained. In addition, in a case where with the inclination detector 105 disposed in parallel to the measurement reference surface 110 as shown in FIG. 3A and FIG. 3B, the inclination angle error P_{T}=4° and the inclination angle error P_{ST}=0° are measured in advance and the inclination angle error Y_{T}=0° is adjusted in advance, when the three inclination angle errors Δθ_{b}=P_{O}+P_{R}+P_{T}=0°, Δθ_{d}=P_{O}−Y_{R}+P_{T}=1.7°, and Δθ_{f}=−P_{O}−Y_{R}−P_{T}=−9.7° are measured, the inclination angle error P_{O}=1.7°, the inclination angle error P_{R}=−5.7°, and the inclination angle error Y_{R}=4° are obtained, and when the length L of the rotary member 107 is assumed to be 300 mm, the parallelism E_{T}=L tan (P_{O})=300× tan (1.7°)=8.9 mm is obtained and the parallelism E_{T}=L tan (P_{R}+P_{T}−P_{ST})=300× tan (−5.7°+4°−0°)=−8.9 mm is obtained.

The method can be used even for a case in which the rotary member 107 is disposed at a given measurement angle in the roll direction centered on the rotary member axis line 108 with respect to the direction perpendicular to the measurement reference surface 110. This is effective when the rotation range of the rotary member 107 is limited to a specific measurement angle range in the roll direction centered on the rotary member axis line 108. As shown in FIG. 2, when θ rotation around the x-axis, P rotation around the y-axis, and Y rotation around the z-axis are set and a reference vector is provided on a given line of the inclination detector 105 as below (the original position is any position),

$$\vec{{P}_{ORG}} = ( {x}_{0} , 0 , 0 ) \qquad [ MATH . 8 ]$$

the reference vector after θ rotation around the x-axis is expressed as follows:

$$\vec{{P}_{1 θ}} = ( \begin{matrix}1 & 0 & 0 \\ 0 & cos ( θ ) & - s in ( θ ) \\ 0 & sin ( θ ) & cos ( θ )\end{matrix} ) \vec{{P}_{O R G}} = {R}_{x} ( θ ) \vec{{P}_{O R G}} \qquad [ MATH . 9 ]$$

the reference vector after P rotation around the y-axis is expressed as follows:

$$\vec{{P}_{1 P}} = ( \begin{matrix}cos ( P ) & 0 & sin ( P ) \\ 0 & 1 & 0 \\ - sin ( P ) & 0 & cos ( P )\end{matrix} ) \vec{{P}_{O R G}} = {R}_{y} ( P ) \vec{{P}_{O R G}} \qquad [ MATH . 10 ]$$

the reference vector after Y rotation around the z-axis is expressed as follows.

$$\vec{{P}_{1 Y}} = ( \begin{matrix}cos ( Y ) & - sin ( Y ) & 0 \\ sin ( Y ) & cos ( Y ) & 0 \\ 0 & 0 & 1\end{matrix} ) \vec{{P}_{O R G}} = {R}_{z} ( Y ) \vec{{P}_{O R G}} \qquad [ MATH . 11 ]$$

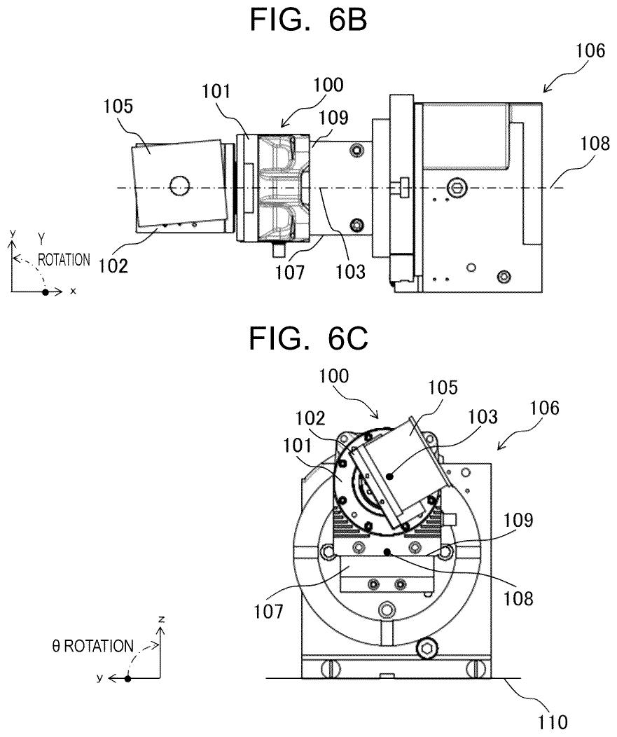

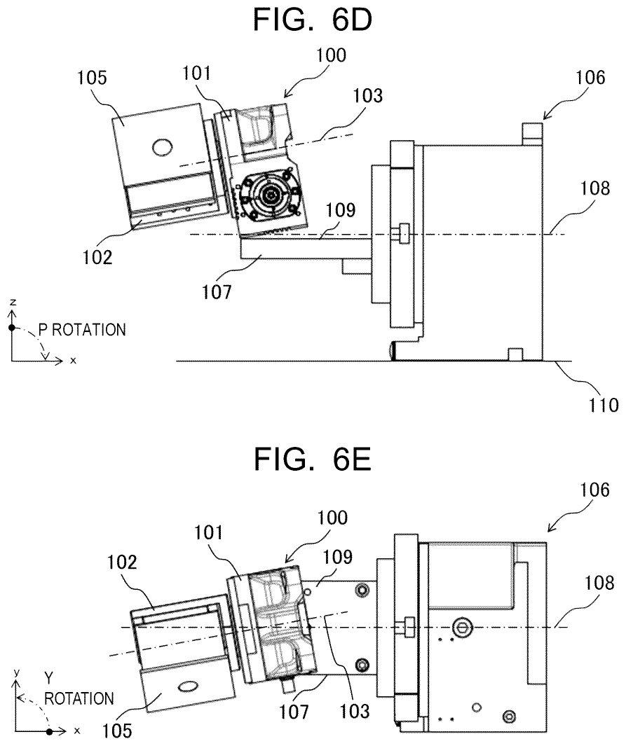

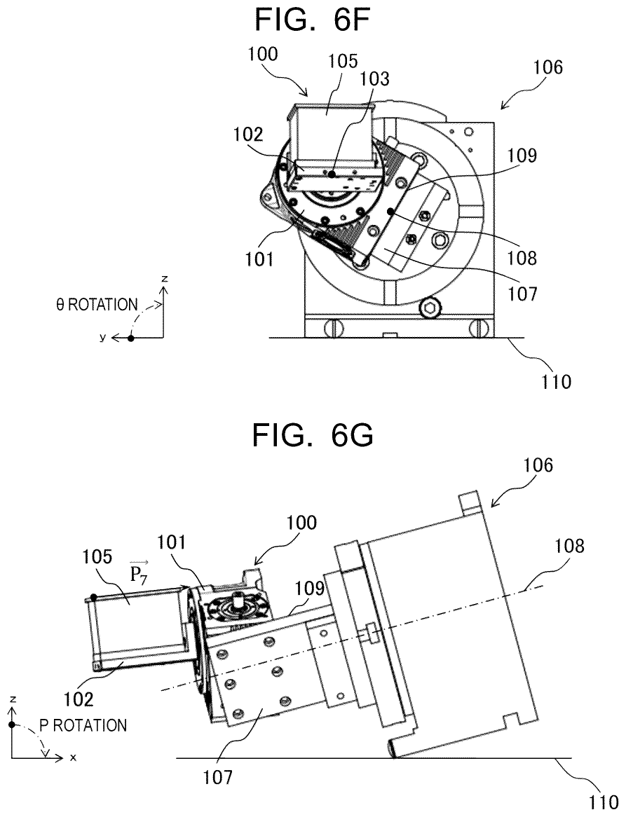

As shown in FIG. 6A, when the inclination angle error P_{T} is present in the counterclockwise direction around the y-axis, with the angle in the clockwise direction (P rotation) around the y-axis assumed to be a positive angle, the inclination detector 105 is rotated around the y-axis by −P_{T}, and a vector P₁ is obtained from a reference vector P_{ORG} as follows:

$$\vec{{P}_{1}} = {R}_{y} ( - {P}_{T} ) \to \vec{{P}_{ORG}} \qquad [ MATH . 12 ]$$

As shown in FIG. 6B, when the inclination angle error Y_{T} is present in the clockwise direction around the z-axis, with the angle in the counterclockwise direction (Y rotation) around the z-axis assumed to be a positive angle, the inclination detector 105 is rotated around the z-axis by −Y_{T}, and a vector P₂ is obtained from the vector P₁ as follows:

$$\vec{{P}_{2}} = {R}_{z} ( - {Y}_{T} ) \vec{{P}_{1}} \qquad [ MATH . 13 ]$$

As shown in FIG. 6C, when the inclination detector 105 (support member 102) is rotated by θ around the x-axis (about the support member axis line 103) by the rotating mechanism 101, with the angle in the clockwise direction (0 rotation) around the x-axis assumed to be a positive angle, a vector P₃ is obtained from the vector P₂ as follows:

$$\vec{{P}_{3}} = {R}_{x} ( θ ) \vec{{P}_{2}} \qquad [ MATH . 14 ]$$

As shown in FIG. 6D, when the inclination angle error P_{R} is present in the counterclockwise direction around the y-axis, with the angle in the clockwise direction (P rotation) around the y-axis assumed to be a positive angle, the measuring device 100 is rotated around the y-axis by −P_{R}, and a vector P₄ is obtained from the vector P₃ as follows:

$$\vec{{P}_{4}} = {R}_{y} ( - {P}_{R} ) \vec{{P}_{3}} \qquad [ MATH . 15 ]$$

As shown in FIG. 6E, when the inclination angle error Y_{R} is present in the clockwise direction around the z-axis, with the angle in the counterclockwise direction (Y rotation) around the z-axis assumed to be a positive angle, the measuring device 100 is rotated around the z-axis by −Y_{R}, and a vector P₅ is obtained from the vector P₄ as follows:

$$\vec{{P}_{5}} = {R}_{z} ( - {Y}_{R} ) \vec{{P}_{4}} \qquad [ MATH . 16 ]$$

As shown in FIG. 6F, when the rotary member 107 is rotated by −θ around the x-axis (about the rotary member axis line 108), with the angle in the clockwise direction (θ rotation) around the x-axis assumed to be a positive angle, a vector P₆ is obtained from the vector P₅ as follows:

$$\vec{{P}_{6}} = {R}_{x} ( - θ ) \vec{{P}_{5}} \qquad [ MATH . 17 ]$$

As shown in FIG. 6G, when the inclination angle error P_{O} is present in the counterclockwise direction around the y-axis, with the angle in the clockwise direction (P rotation) around the y-axis assumed to be a positive angle, the inclination circular table 106 is rotated around the y-axis by −P_{O}, and a vector P₇ is obtained from the vector P₆ as follows.

$$\vec{{P}_{7}} = {R}_{y} ( - {P}_{0} ) \vec{{P}_{6}} \qquad [ MATH . 18 ]$$

By rotating the reference vector P_{ORG} as shown in FIG. 6A to FIG. 6G, the final vector P₇ is obtained from the reference vector P_{ORG} as follows:

$$\vec{{P}_{7}} = {R}_{y} ( - {P}_{0} ) {R}_{x} ( - θ ) {R}_{Z} ( - {Y}_{R} ) {R}_{y} ( - {P}_{R} ) {R}_{x} ( θ ) {R}_{Z} ( - {Y}_{T} ) {R}_{y} ( - {P}_{T} ) \vec{{P}_{O R G}} = ( {x}_{7} , {y}_{7} , {z}_{7} ) \qquad [ MATH . 19 ]$$

the inclination angle ΔP measured by the inclination detector 105 is obtained as follows:

$$Δ P = {tan}^{- 1} ( \frac{{z}_{7}}{{x}_{7}} ) \qquad [ MATH . 20 ]$$

and, further, the following equation is obtained.

$${z}_{7} - {x}_{7} tan ( Δ P ) = {f}_{\#} ( {P}_{R} , {Y}_{R} , {P}_{0} , {P}_{T} , {Y}_{T} {6}_{\#} , Δ {P}_{\#} ) = 0 \qquad [ MATH . 21 ]$$

# is a measurement number. When the inclination angle errors P_{T} and Y_{T} are measured or adjusted in advance as shown above, the three inclination angle errors P_{R}, Y_{R}, and P_{O} are unknown at a given measurement angle θ_{#} centered on the rotary member axis line 108 of the rotary member 107. Therefore, at the given measurement angle θ #=1 to 3, the following three formulae are obtained from the inclination angle ΔP_{#=1 to 3} measured by the inclination detector 105.

$${f}_{\# = 1 ∼ 3} ( {P}_{R} , {Y}_{R} , {P}_{0} , {P}_{T} , {Y}_{T} , {θ}_{\# = 1 ∼ 3} , Δ {P}_{\# = 1 ∼ 3} ) = 0 \qquad [ MATH . 22 ]$$

The inclination angle errors P_{R}, Y_{R}, and P_{O} can be obtained by solving the simultaneous equations based on these three formulae. Further, since the inclination angle error P_{ST} can be measured or adjusted in advance as shown above, the parallelism E_{A1} and E_{T} can also be obtained.

When the inclination angle errors P_{T} and Y_{T} are not measured or adjusted in advance, the five inclination angle errors P_{R}, Y_{R}, P_{O}, P_{T}, and Y_{T} are unknown at the given measurement angle θ_{#} centered on the rotary member axis line 108 of the rotary member 107. Therefore, at the given measurement angle θ_{#=1 to 5}, the following five formulae are obtained from the inclination angle ΔP_{#=1 to 5} measured by the inclination detector 105.

$${f}_{\# = 1 ∼ 5} ( {P}_{R} , {Y}_{R} , {P}_{0} , {P}_{T} , {Y}_{T} , {θ}_{\# = 1 ∼ 5} , Δ {P}_{\# = 1 ∼ 5} ) = 0 \qquad [ MATH . 23 ]$$

The inclination angle errors P_{R}, Y_{R}, P_{O}, P_{T}, and Y_{T} can be obtained by solving the simultaneous equations of these five formulae. Further, since the inclination angle error P_{ST} can be measured or adjusted in advance as shown above, the parallelism E_{A1} and E_{T} can also be obtained.

It should be further understood by persons skilled in the art that although the foregoing description has been made on embodiments of the present invention, the present invention is not limited thereto and various changes and modifications may be made without departing from the principle of the present invention and the scope of the appended claims.

### REFERENCE SIGNS LIST

100 measuring device
101 rotating mechanism
102 support member
103 support member axis line
104 angle detector
105 inclination detector
106 inclination circular table
107 rotary member
108 rotary member axis line
109 measurement surface
110 measurement reference surface

1. A method for measuring a state of a rotary member rotatable about a rotary member axis line, the method comprising the steps of:
disposing a measuring device on a measurement surface of the rotary member, the measuring device including: a rotating mechanism; a support member that can be rotated about a support member axis line by the rotating mechanism; an angle detector that detects a rotation angle of the support member; and an inclination detector that is disposed on the support member and detects an inclination angle of the inclination detector with respect to a measurement reference surface;
disposing the rotary member at a first measurement angle centered on the rotary member axis line;
disposing the support member such that a first rotation angle centered on the support member axis line corresponding to the first measurement angle is detected by the angle detector;
measuring a first inclination angle of the inclination detector with respect to the measurement reference surface at the first rotation angle of the support member by the inclination detector; and
measuring the state of the rotary member based on at least the first inclination angle.

2. The method according to claim 1, further comprising the steps of:
rotating the rotary member from the first measurement angle to a second measurement angle about the rotary member axis line;
rotating the support member such that a second rotation angle centered on the support member axis line corresponding to the second measurement angle is detected by the angle detector;
measuring a second inclination angle of the inclination detector with respect to the measurement reference surface at the second rotation angle of the support member by the inclination detector; and
measuring the state of the rotary member further based on the second inclination angle.

3. The method according to claim 2, further comprising the steps of:
rotating the rotary member from the second measurement angle to a third measurement angle about the rotary member axis line;
rotating the support member such that a third rotation angle centered on the support member axis line corresponding to the third measurement angle is detected by the angle detector;
measuring a third inclination angle of the inclination detector with respect to the measurement reference surface at the third rotation angle of the support member by the inclination detector; and
measuring the state of the rotary member further based on the third inclination angle.

4. The method according to claim 1, further comprising the steps of:
measuring a fourth inclination angle of the inclination detector with respect to the measurement reference surface by the inclination detector, by arranging the measurement surface so as to be parallel to the measurement reference surface; and
measuring the state of the rotary member further based on the fourth inclination angle.

5. The method according to claim 4, further comprising the step of adjusting an angular position of the inclination detector so as to be aligned with the support member axis line.

6. The method according to claim 4, further comprising the steps of:
measuring a fifth inclination angle of the inclination detector with respect to the measurement surface, by disposing the support member at a first angle centered on the support member axis line;
measuring a sixth inclination angle of the inclination detector with respect to the measurement surface, by rotating the support member by 180° from the first angle to a second angle about the support member axis line; and
measuring an inclination angle of the support member axis line with respect to the measurement surface based on the fifth inclination angle and the sixth inclination angle.

7. The method according to claim 1, wherein the inclination detector is a spirit level.

8. The method according to claim 1, wherein the state of the rotary member includes parallelism of the rotary member axis line with respect to the measurement reference surface.

9. The method according to claim 7, wherein the state of the rotary member includes parallelism of the measurement surface with respect to the rotary member axis line.

10. The method according to claim 9, wherein the first measurement angle, the second measurement angle, and the third measurement angle are an angle of 0°, 90°, or −90° centered on the rotary member axis line with respect to a direction perpendicular to the measurement reference surface.
